(19) United States
(12) Patent Application Publication
(10) Pub. No.: US 2022/0123416 A1
(43) Pub. Date: Apr. 21, 2022

(54) SYSTEMS AND METHODS FOR REMOVABLE BATTERY LOCKING

(71) Applicant: Yaakov Oren Ben Shabat, Bnei Brak (IL)

(72) Inventor: Yaakov Oren Ben Shabat, Bnei Brak (IL)

(21) Appl. No.: 17/434,020

(22) PCT Filed: Feb. 6, 2020
(86) PCT No.: PCT/IL2020/050144

§ 371 Date: Aug. 26, 2021

(30) Foreign Application Priority Data
Mar. 17, 2019 (IL) 265418

(51) Int. Cl. H01M 50/264; E05B 71/00; B62J 43/20; B60L 53/80; B62J 43/13

(52) U.S. Cl. CPC H01M 50/264; E05B 71/00; H01M 2220/20; B60L 53/80; B62J 43/13; B62J 43/20

(57) ABSTRACT

Systems and methods for a removable battery locking mechanism, comprising: an adjustable rail 100 comprising a bolt 102 connecting a lower segment 103 and an upper segment 104, wherein said adjustable rail allow a user to adjust the rail's length to snuggly accommodate a battery 101 and fit in said battery's rail recess; said rail having opening 105, 106 in its lower and upper segments to allow it to be removably connected to a mobility device using connecting means which are hidden while said battery is connected to said mobility device; said upper and lower segments having protruding parts 108, 109 in the side opposite to said battery adapted to receive said bolt extrude sufficient distance hit said mobility device's frame; said rail's upper segment having a recess 110 adapted to receive said battery's locking pin and reinforced external part adapted to cover said pin; said rail's upper segment having an adjustable screw 111 located in the upper part of said upper segment protruding to the battery side allowing a user to adjust said screw to the touch said battery while inserted.

### BACKGROUND

### 1. Technical Field

Embodiments of the present invention relate generally to systems and methods for removable battery locking.

### 2. Description of Related Art

Many, if not most, personal mobility devices such as electric bicycle, scooters, mobility aids, etc. use batteries to operate. Those batteries are usually rather expensive and have fast wear and tear and hence, the batteries are prone to theft.

Currently, manufacturers of personal mobility devices add some sort of locking mechanism to those batteries but usually those are easy to overcome.

Hence, an improved systems and methods as described in this application are still a long felt need.

### BRIEF SUMMARY

According to an aspect of the present invention a removable battery locking mechanism, comprising: an adjustable rail comprising a bolt connecting a lower segment and an upper segment, wherein said adjustable rail allow a user to adjust the rail's length to snuggly accommodate a battery and fit in said battery's rail recess; said rail having opening in its lower and upper segments to allow it to be removably connected to a mobility device using connecting means which are hidden while said battery is connected to said mobility device; said upper and lower segments having protruding parts in the side opposite to said battery adapted to receive said bolt extrude sufficient distance hit said mobility device's frame; said rail's upper segment having a recess adapted to receive said battery's locking pin and reinforced external part adapted to cover said pin; said rail's upper segment having an adjustable screw located in the upper part of said upper segment protruding to the battery side allowing a user to adjust said screw to the touch said battery while inserted.

It is further within provision of the invention to be wherein said opening are long grooves.

It is further within provision of the invention to be wherein said rail having a part protruding from said upper segment having a cut adapted receive a lock wherein said lock connect to said rail and has sufficient length to disrupt attempts to pull said battery.

It is further within provision of the invention to be wherein said lock is adapted to further connect to said mobility device's chair.

It is further within provision of the invention to be wherein said lock is adapted to further connect to said battery's handle.

It is further within provision of the invention to be wherein said rail having a part protruding from said upper segment having a lockable L shaped lock adapted to disrupt attempts to pull said battery while in locked position and moved to the side and not disrupt attempts to pull said battery while in unlocked position.

It is further within provision of the invention to be wherein said cut is used to mount accessories while not in use by a lock.

It is further within provision of the invention to further comprise a locking chain passing through the gap between said bolt and said battery and allow locking around an object.

It is further within provision of the invention to be further comprise a shock absorber located in said rail's upper segment.

It is further within provision of the invention to further comprise a cable 301 attached in its first end to said lower segment 302 by fastening means 303 accessible only from the internal side of said lower segment and not accessible at all while said battery is attached; said cable is adapted to freely pass in the recess 304 created between said lower and upper segments and/or in the recess 305 created between said battery handle 306 and said battery body and further having a second end which is larger than said recesses 304, 305 in a manner that prevent said second end from moving from one side to the other while said battery is attached.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1-3 illustrates the components of an embodiment of the present invention.

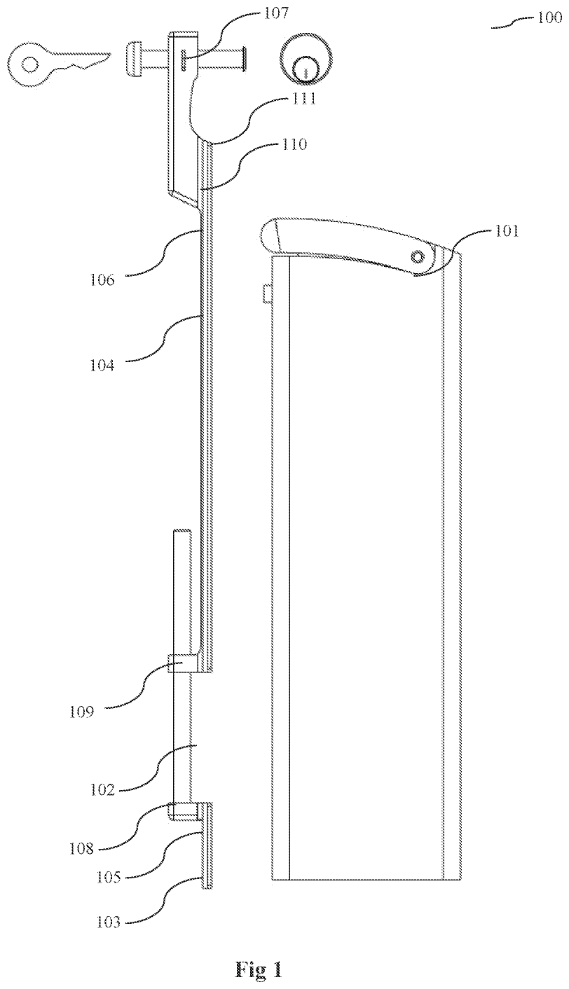

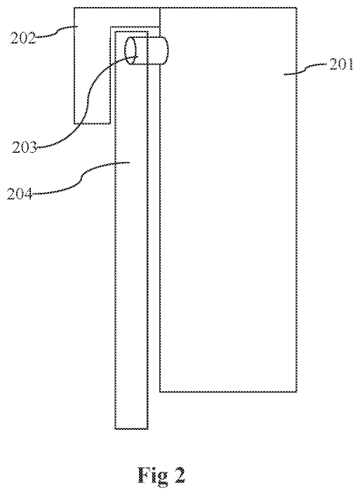

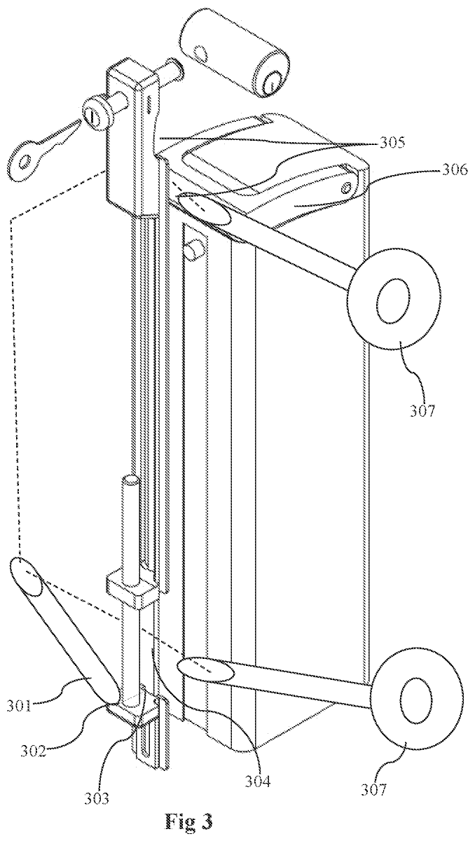

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for battery locking.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g., 1, 5, or 10).

The invention relates to systems and methods that may allow locking a removable battery to a personal mobility device such as an electric bicycle, electric scooter, etc.

Generally speaking, the system and method may allow replacing or modifying the rail on which the battery slide along while inserted and extracted. The invention's rail may allow enhanced locking or anti-theft abilities.

Removable batteries usually have an internal locking cylinder that uses a pin extruding from the battery into a cut or a groove in the original rail and the pin is visible and accessible from the external part of the rail. While, the rail itself fit in a recess in the battery. The top of the rail is also visible and accessible.

Thieves will usually use those two feature to steal a locked battery. They either hit the pin using a hammer and another apparatus such as a metal pin, screw driver, etc. This action will push the locking pin back in and allow the thief to steal the battery. Or, the thief might try to wedge an apparatus, such as a flat faced screw or other metal instrument between the rail and the battery and “pop” the battery's pin out of the rail cut or groove, once again, allowing the thief to steal the battery.

Hence, in an embodiment of the invention, the removable battery locking mechanism may comprise an adjustable rail 100 comprising a bolt 102 connecting a lower segment 103 and an upper segment 104.

The adjustable rail allows a user to adjust the rail's length to snuggly accommodate a battery 101 and fit in said battery's rail recess. This feature may allow a user to use the invention's apparatus with multiple batteries in different lengths.

The rail may have opening 105, 106 in its lower and upper segments to allow it to be removably connected to the mobility device using connecting means which may be hidden while the battery is connected to the mobility device. This may disallow a thief to remove the rail itself in order to steal the battery. The battery itself may hide the screws and disallow access to them.

The upper and lower segments may have extruding parts 108, 109 in the side opposite to the battery. Those parts may be adapted to receive the bolt and hence allow a user to extend the length of the rail to accommodate the battery.

In some embodiments of the invention, those part protrude a sufficient distance so they may hit the mobility device's frame and hence add another layer of protection that disallow a thief to pull it up.

The rail's upper segment may have a recess 110 adapted to receive the battery's locking pin and a reinforced external part adapted to cover that pin. This reinforced external part hides the pin from plain sight and disallow hitting it from behind or to bend the rail.

The rail's upper segment may have an adjustable screw 111 located in the upper part of the upper segment protruding to the battery side and may allow a user to adjust the screw to touch the battery while it is inserted. This screw may disallow a thief to stick an apparatus, such as flat headed screwdriver in an attempt to “pop” the pin from the cut or groove it is locked in. In addition, the screw may block, as in some embodiments of the invention, attempt to pull the battery. In further embodiments of the invention, the screw may be spring loaded and may be actuated with the insertion of the battery into place.

In some embodiments of the invention, the opening 105, 106 are long grooves that may allow a user to connect the invention's rail to the mobility device in different locations, making it easier to manufacture a versatile rail that may be used on more than one model of mobility device.

In some embodiments of the invention, the rail may have a part protruding from the upper segment that may have a cut adapted receive a lock 107 wherein the lock may connect to the rail and has sufficient length to disrupt attempts to pull said battery as it may protrude above the top of the battery. Such lock may be, as in some embodiments of the invention, any lock that may cover the top of the battery.

In further embodiments of the invention, the lock may be adapted to further connect to the mobility device's Chair. For example, by using a protruding part that goes beneath the seat and connect to one of its parts.

In some embodiments of the invention, the lock is may be adapted to further connect to the battery's handle as another layer of protection.

In some embodiments of the invention, the rail may have a part protruding from the upper segment having a lockable L shaped lock that may be adapted to disrupt attempts to pull the battery while in locked position and moved to the side and not disrupt attempts to pull the battery while in unlocked position. In further embodiments of the invention, such may be achieved using a pin passing through the reinforced external part, the pin may have a recess adapted to receive the battery's locking pin and lock the pin into place. The locking position may be such that the upper protruding part be positioned in manner that prevent the pulling of the battery upward.

In some embodiments of the invention, the cut may be used to mount accessories while not in use by a lock.

In some embodiments of the invention, the apparatus may further comprise a locking chain passing through the gap between the bolt and the battery and allow locking around an object. This may allow locking the entire mobility device to an object like a bicycle locking station, etc.

In an embodiment of the invention, a battery 201 locking mechanism, comprising a reinforced external part 202 adapted to cover battery's locking pin 203 may be used to achieve the goals mentioned above, when the rail 204 may enter said cavity created by the reinforced external part and allow the pin to lock into a recess in the rail.

In some embodiments of the invention, the apparatus may further comprise a shock absorber located on the battery side of the rail's upper segment.

In an embodiment of the invention, a cable 301 may be attached in its first end to the lower segment 302. Such may be achieved using fastening means 303, such as a screw or bolt, which may be accessible only from the internal side of the lower segment. As it only accessible from the internal side, once the battery is attached it may be inaccessible at all and hence prevent tempering with it. As can be appreciated, the term “cable” in this application may be used to describe any cable, chain, locking wire or other interchangeable apparatuses.

The cable may be adapted to freely pass in the recess 304 created between the lower and upper segments, as in one embodiment of the invention, or in the recess 305 created between said battery and said upper segment, as in another embodiment. The cable's second end may be larger than the recesses 304, 305 in a manner that prevent the second end from moving from one side to the other while the battery is attached, as such, the cable may be allowed to be wrapped around or through an object and then secured by going through the recesses.

In further embodiments, the second end may further be adapted to be locked using locking means, such as a U shaped lock, embedded lock, etc.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A battery locking mechanism for a battery of a mobility device, comprising:
a battery side configured for attachment to a rail recess in said battery;
a pin recess 110 having an open side adapted to receive locking pin of the battery; and
said pin recess closed on a side opposite said battery by a reinforced external part of said locking mechanism adapted to cover said pin and said pin recess.

2. The movable battery locking mechanism of claim 1, further comprising:
an adjustable protrusion 111 protruding from said battery side and located above said pin recess and configured to touch said battery when said locking mechanism is attached to said rail recess.

3. The locking mechanism of claim 16, wherein wherein said openings 105, 106 include elongated grooves.

4. The locking mechanism of claim 1, further comprising a lock 107 and wherein the locking mechanism includes a cut adapted receive the lock 107 and wherein when the locking mechanism is attached to the rail recess and said lock 107 is locked to the locking mechanism, said lock 107 protrudes from the battery side far enough to disrupt attempts to pull said battery past said lock to disconnect the battery from the locking mechanism.

5. The locking mechanism of claim 4, wherein said lock is adapted to further connect to a chair of said mobility device.

6. The locking mechanism of claim 4, wherein said lock is adapted to further connect to a handle of said battery.

7. The locking mechanism of claim 1, further comprising a protruding part having a lockable L shaped lock adapted to disrupt attempts to pull said battery while in locked position and which is configured to be moved to the side and not disrupt attempts to pull said battery while in an unlocked position.

8. The locking mechanism of claim 4 wherein said cut is is configured to mount accessories while not in use by a lock.

9. The locking mechanism of claim 17, further comprising a locking chain passing through a gap between said connector and said battery and allow locking around an object.

10. The locking mechanism of claim 14, further comprising a shock absorber located in an upper segment of said rail.

11. A battery locking mechanism, comprising a reinforced external part 202 attached to the battery and adapted to cover battery's locking pin 203 while allowing a rail 204 to enter and achieve locking of said pin and said rail.

12. The locking mechanism of claim 17, further comprising:
a cable 301 attached in its first end to said lower segment 302 by fastening means 303 accessible only from an internal side of said lower segment and not accessible while said battery is attached; said cable is adapted to freely pass in at least one recess selected from a recess 304 created between said lower and upper segments—and a recess 305 created between said battery and said upper segment the cable including a second end which is larger than said at least one recesses 304, 305 in a manner that prevent said second end from moving from one side to the other while said battery is attached.

13. The locking mechanism of claim 12 further wherein said second end is adapted to be locked to said locking mechanism.

14. The locking mechanism of claim 1, wherein said a battery side includes a rail 100 fitting said rail recess to connect said locking mechanism to said battery.

15. The locking mechanism of claim 14, wherein said rail has an adjustable length to snuggly accommodate a battery 101 while fit in said rail recess.

16. The locking mechanism of claim 14, where said rail has opening 105, 106 in a lower segment and an upper segment facilitating removable connection to the mobility device using connecting means which are hidden while said battery is connected to said mobility device.

17. The locking mechanism of claim 15, wherein said rail includes an upper segment having a first protruding part 108 and a lower segment having a second protruding part 109, said first and second protruding parts protruding from a side opposite to said battery when the rail is inserted into said rail recess and a connector adapted to connect said first protruding part to said second protruding part.

18. The locking mechanism of claim 17, wherein said connector includes a bolt.

19. The locking mechanism of claim 17, wherein said first protruding part protrudes a sufficient distance to hit a frame of said mobility and block upward movement when the rail is pulled upward while attached to the battery.
